(19) United States
(12) Patent Application Publication
(10) Pub. No.: US 2024/0209999 A1
(43) Pub. Date: Jun. 27, 2024

(54) Through Wall Lighting Optical Element; Through Wall Lighting System; Wind Turbine Light

(71) Applicant: Orga Holding B.V., Schiedam (NL)

(72) Inventors: Pieter Gerardus GOEDKNEGT, Maassluis (NL); Thomas LEEUWANGH, Rhoon (NL)

(21) Appl. No.: 18/086,385

(22) Filed: Dec. 21, 2022

(51) Int. Cl. F21S 8/02; F03D 80/10; F21V 5/04

(52) U.S. Cl. CPC F21S 8/024; F03D 80/10; F21V 5/04

(57) ABSTRACT

Through wall lighting optical element for arrangement in a through hole of a wall of a wind turbine, comprising: a light source; a light transmitting element comprising a first end and a second end opposite to the first end, wherein the first end is coupled with the light source, wherein the first end is to be located inside the wall; and a light directing element coupled with the second end of the light transmitting element for directing light outwardly from the through hole of the wall.

### BACKGROUND

Lighting installations may be provided to wind turbines for safety reasons as well as for compliance with regulations concerning marking lights such that a wind turbine be visible to aeronautical vehicles or other vessels.

### SUMMARY

According to an aspect of the disclosure there is provided a through wall lighting optical element for arrangement in a through hole of a wall of a wind turbine, comprising a light source and a light directing element for directing light outwardly from the through hole of the wall. When the optical element is installed in the through hole, the light source is located inside of the through hole of the wall.

When installed in the through hole of the wall of the wind turbine, the light source extends at least partly inside of the hole, in particular in between an inner side of the wall and an outer side of the wall.

The optical element may further comprise a light transmitting element comprising a first end and a second end opposite to the first end, wherein the first end is coupled with the light source and wherein the light directing element is coupled with the second end of the light transmitting element.

There is also provided for a through wall lighting optical element for arrangement in a through hole of a wall of a wind turbine, comprising a light source, a light transmitting element comprising a first end and a second end opposite to the first end, and a light directing element coupled with the second end of the light transmitting element for directing light outwardly from the through hole of the wall. The first end is coupled with the light source, wherein the first end is to be located inside the wall, in particular inside of the through hole of the wall. The second end is to be located near an outer side of the wall.

The optical element can provide a means for providing light to be emitted from the wind turbine into the environment of the wind turbine, such that the wind turbine is visible for aeronautical traffic.

By arranging the optical element in a through hole of the wall, installation, maintenance and removal of the optical element from the inside of a wind turbine is made possible. This is contrary to conventional wind turbine lighting devices, wherein installation needs to be done from the outside of the wind turbine, introducing a high risk of accidents and high costs.

Further, by providing a light transmitting element, a distance between the light source and the outside of the wall can be provided. The light transmitting element may e.g. comprise a wave guide or a tube comprising a reflective inner surface. The light transmitting element can have various lengths, but is shorter than the length of the through hole of the wall of the wind turbine, such that the first end is to be located inside the through hole, between an inner side of the wall and an outer side of the wall. The first end of the light transmitting element can be near the inner side of the wall, or can be in the middle between the inner side and the outer side, or can be near the outer side of the wall, or at any other position between the inner side and the outer side.

The light directing element provides a focusing of the light in certain directions, providing an efficient use of the energy emitted by the light source. By providing the light directing element, it can be possible to comply with certain regulations concerning emitted light in some directions, e.g. related to light pollution, or a predefined light emitting pattern can be provided for emitting light into the environment of the wind turbine tower.

The through hole connects an inner side of the wall with an outer side of the wall and the through hole comprises two openings, one on the inner side of the wall and the other on the outer side of the wall. The through hole may comprise a cylindrical shape, a beam shape, or any other shape. Each of the openings may comprise a circle shape, a rectangular shape, or any other shape. More complex shapes may be advantageous for an easy installation or a better fixation to the wall, e.g. the two openings may have a different shape, i.e. the through hole may have a varying cross-sectional shape throughout the wall width, or the through hole may comprise a more complex cross section.

The light source may be arranged between the two openings of the through hole of the wall, such that the light source is provided inside the wall. During operation of the optical element, the light source is positioned at an inside of the through hole. The light source is to be installed within the through hole of the wall, between the opening on the inner side of the wall and the opening on the outer side of the wall.

By providing the light source anywhere along the through hole inside of the wall, the disclosure provides a solution which is an improvement, on the one hand, over providing the light source outside of the wind turbine and, on the other hand, over providing the light source inside of the wind turbine.

The light source may be a collimated light source, e.g. a collimated LED, a collimated LED array, a laser, a light bulb combined with a collimating lens.

The light source may comprise a collimating optic for collimating light emitted by the light source, e.g. before the light is guided through the light transmitting element.

The collimating optic may comprise at least one lens.

Further, the light source may comprise a laser or at least one LED.

The light directing element may comprise at least one lens.

The light transmitting element may advantageously have a substantially cylindrical shape, or a shape corresponding with the shape of the through hole. The light transmitting element may comprise one or more mirroring elements.

The disclosure further provides a through wall lighting system comprising an optical element as described herein and a housing, wherein the light transmitting element is arranged inside the housing or wherein the light transmitting element comprises the housing. A light transmitting element of the optical element may comprise a housing. Thus, the light optical element itself may comprise the housing as an integral part of the light transmitting element. The housing and/or the light transmitting element may have a shape corresponding with the shape of the through hole in the wall of the wind turbine, to ensure a good fit of the housing and/or the light transmitting element in the through hole.

The housing and the light transmitting element may have a similar or the same length seen along a central axis of the through hole, or may comprise a different length. The housing may e.g. be longer or shorter than the light transmitting element. The housing may thus entirely surround a circumference of the light transmitting element or may surround a part of a circumference of the light transmitting element. The housing may also entirely or partially surround a circumference of the optical element.

The light source may be arranged inside the housing for protection against external forces and to shield the light source from any dust or dirt etc. Such a housing may also protect the light source against water or other moisture, e.g. from rain or fog or sea spray.

The lighting system may further comprise a controller for operating the optical element and a power supply for powering the light source, the power supply comprising an electrical connection element, e.g. a cable, for connecting the power supply with the light source.

When the optical element is installed in the through hole, the electrical connection element may be at least partially located inside the through hole. By providing the electrical connection element at least partially inside the through hole, more space is saved and the lighting system takes up less room within the wind turbine. The electrical connection element may e.g. be an electrical cable or wire and/or may comprise a connector such as a plug. The electrical connection element may comprise multiple connection elements which are connected together.

When the optical element is installed in the through hole, the power supply may be at least partially located inside the through hole. By providing the power supply at least partially inside the through hole, even more space is saved and a more compact solution is provided. Such an optical element may also be more convenient for installation.

The housing may entirely or partially comprise and/or enclose the controller, the power supply and/or the electrical connection element.

The housing may be affixed to the wall by a fixation element. The fixation element may e.g. comprise an attachment bracket, one or more flanges, grooves on an outer surface of the housing, or any other means for fixing the housing to the wall.

The fixation element may be a flange arranged on one end of the housing. Such a flange arranged on one end of the housing may also merely or additionally be provided as a stop element to ease installation of the lighting system. A desired position of the lighting system along a central axis of the through hole can be reached by providing a flange on the housing, or by providing another type of marking on the housing.

The system may also comprise an auxiliary element for comprising a receiving space for receiving a power supply and/or a controller, and/or other components of the lighting system, e.g. an electrical connection element, a back-up power supply etc. The auxiliary element may coincide with the fixation element, for example in the case of a bracket.

The lighting system may further comprise a sealing element arranged at an outer surface of the housing, wherein, after installation, the sealing element makes contact with an inner surface of the through hole. By providing a sealing element, the inside of the wind turbine is to be sealed off from the outside of the wind turbine. Additionally, the lighting system is protected from external effects, such as dust, dirt, moisture, etc. The sealing element may also comprise the fixation element and the fixation element may also comprise the sealing element.

The housing may have a substantially cylindrical shape, or a shape corresponding with the shape of the through hole.

Further, the disclosure provides a wind turbine comprising a lighting system as described herein.

### BRIEF DESCRIPTION OF THE DRAWINGS

FIG. 1 shows a schematic cross section of a turbine wall comprising a through hole, wherein a lighting system according to the disclosure is arranged in the through hole.

FIG. 2 shows a schematic cross section of a turbine wall comprising a through hole, wherein a lighting system according to the disclosure is arranged in the through hole.

FIG. 3 shows a schematic cross section of a turbine wall comprising a through hole, wherein a lighting system according to the disclosure is arranged in the through hole.

FIG. 4 shows a schematic cross section of a turbine wall comprising a through hole, wherein a lighting system according to the disclosure is arranged in the through hole.

FIG. 5 shows a schematic cross section of a turbine wall comprising a through hole, wherein a lighting system according to the disclosure is arranged in the through hole.

FIG. 6 shows a schematic cross section of a turbine wall comprising a through hole, wherein a lighting system according to the disclosure is arranged in the through hole.

FIG. 7 shows a schematic cross section of a turbine wall comprising a through hole, wherein a lighting system according to the disclosure is arranged in the through hole.

FIG. 8 shows a schematic cross section of a turbine wall comprising a through hole, wherein a lighting system according to the disclosure is arranged in the through hole.

### DETAILED DESCRIPTION

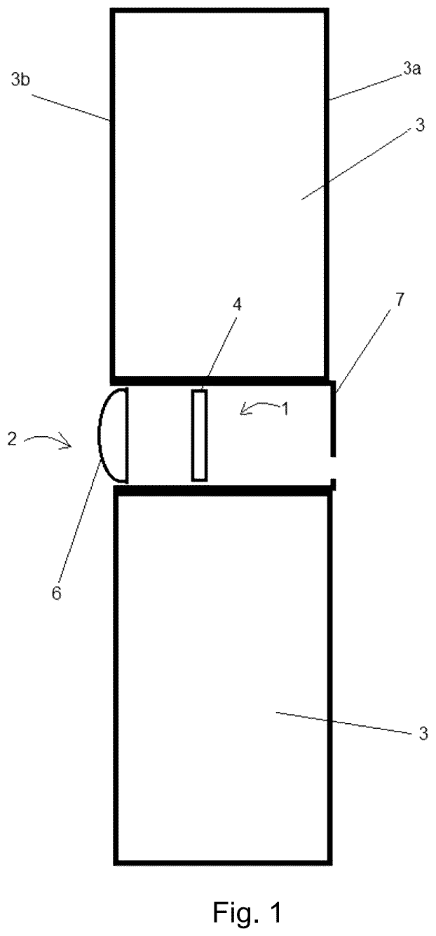

In FIG. 1, an optical element 1 according to the disclosure is shown, comprising a light source 4 and a light directing element 6. The light source 4 is arranged inside the through hole of the wall 3. The optical element 1 is optionally arranged inside a housing 7, therewith forming a lighting system 2. As FIG. 1 illustrates, the light source 4 may optionally be arranged nearer to an outer side 3b of the wall 3 than to an inner side 3a of the wall 3.

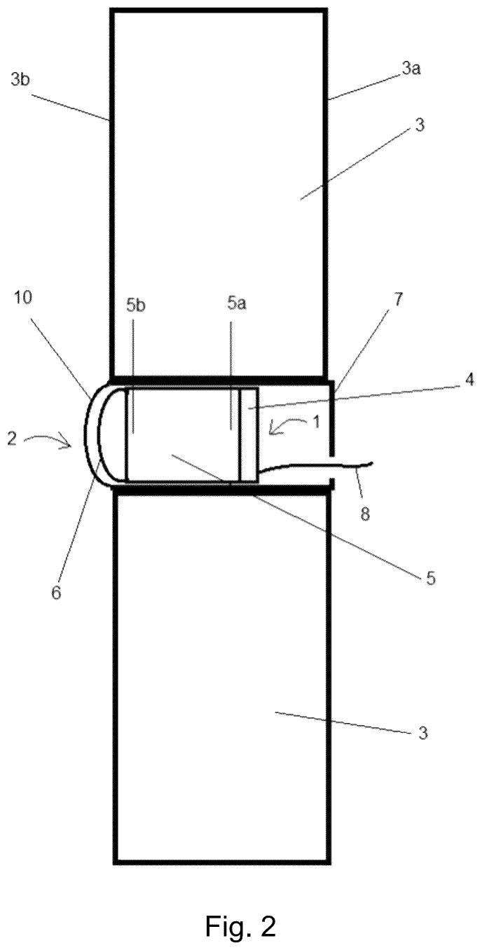

FIG. 2 shows an optical element 1 arranged in a through hole of a wall 3, the optical element 1 comprising a light source 4, a light transmitting element 5 and a light directing element 6. The light transmitting element 5 comprises a first end 5a, which is coupled with the light source 4 and a second end 5b opposite the first end which is coupled to the light directing element 6 for directing light outwardly from the through hole of the wall 3. The second end 5b is to be located near an outer side 3b of the wall 3, e.g. nearer to an outer side 3b of the wall 3 than to an inner side 3a of the wall 3. The first end 5a is to be located inside the wall 3, i.e. between the outer side 3d and the inner side 3a of the wall 3, and near the inner side 3a of the wall 3, e.g. nearer to the inner side 3a of the wall 3 than to the outer side 3b of the wall 3.

As shown in FIG. 2, when the optical element 1 is installed in the through hole, the light source 4 is located inside of the through hole of the wall, between the two through hole ends, surrounded by the wall 3 along a circumference of the light source 4, i.e. enclosed by the wall 3 with or without contacting the wall 3.

The light source 4 may e.g. be a collimated light source, emitting collimated light. To this end, the light source 4 may comprise a collimating optic for collimating light emitted by the light source 4 before the light is guided through the light transmitting element 5. The collimating optic may comprise at least one lens. The light source 4 may e.g. comprise a laser or at least one LED, e.g. an array of LEDs. The light source 4 may comprise an array of LEDs covered with a collimating optic.

The light transmitting element 5 may comprise a substantially cylindrical shape. The light transmitting element 5 may follow the shape of the through hole. Shown in the figures is a through hole with a constant cross section, but as mentioned above, through holes with a cross section varying along their main axis are also envisaged.

The light directing element 6 may comprise at least one lens, e.g. eliminating or reducing a vertical light component, and may comprise at least one reflective or mirroring surface.

FIG. 2 further shows a lighting system 2 comprising the optical element 1 and a housing 7, wherein the light transmitting element 5 is arranged inside the housing. It is noted that, although the figures illustrate the light source 4 and the light directing element 6 as allocated inside the housing 7, the inventor's idea does not require for the light source 4 or the light directing element 6 to be arranged inside the housing 7. The light source 4 being arranged inside the housing 7 is optional.

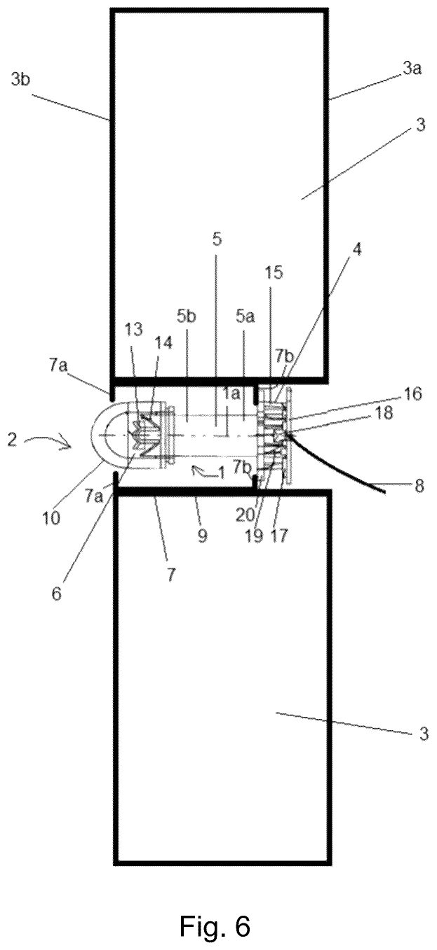

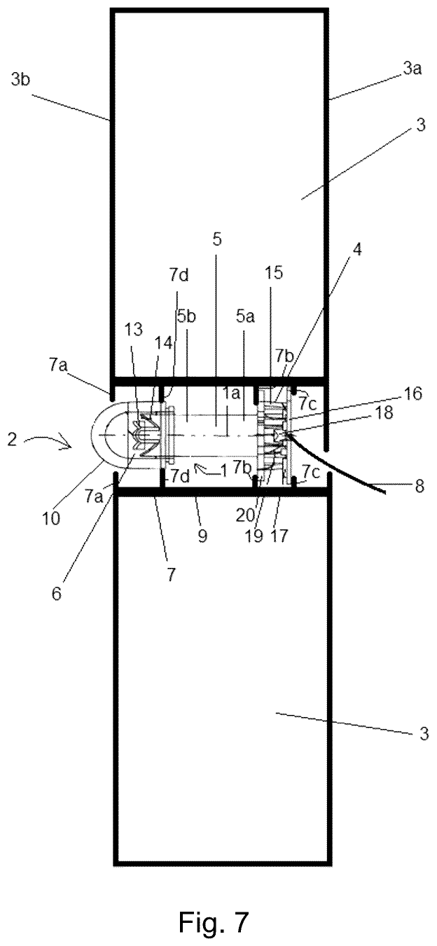

FIG. 2 shows a dome 10 comprised by the lighting system 2 at an end of the housing 7. However, the dome 10 may also be comprised by the optical element 1, as illustrated in FIG. 6-7. The housing 7 may be completely or partially open at the end of the through hole on the outer side 3b of the wall 3.

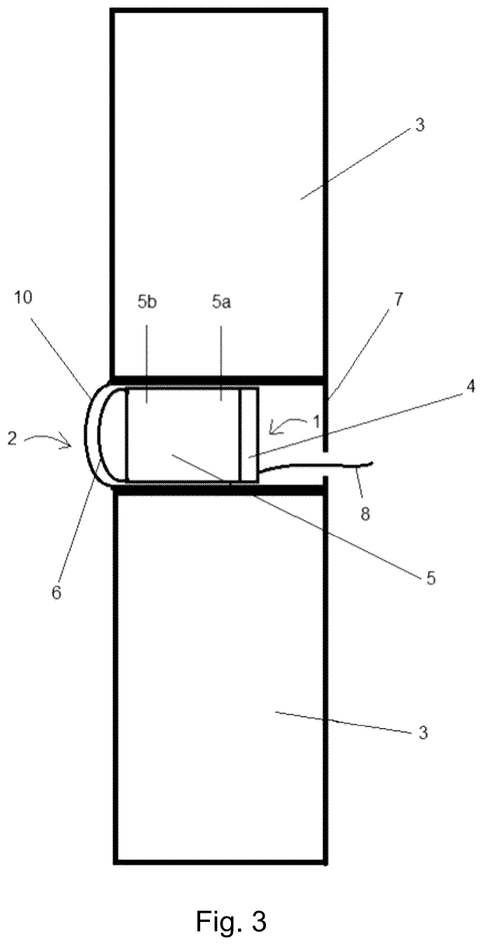

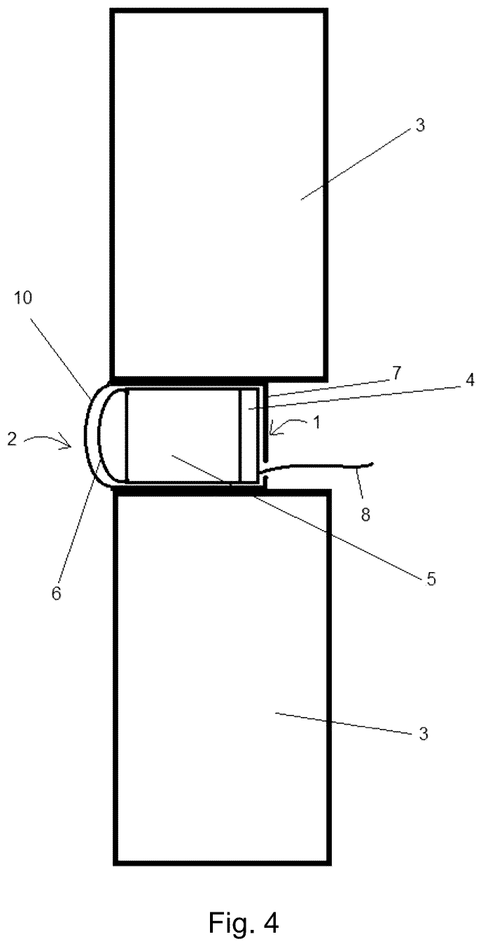

In FIG. 2, the housing is depicted as protruding to the inside of the turbine, however, the housing may also not protrude to the inside of the turbine, and may even end well inside the through hole, as illustrated in FIGS. 3 and 4 respectively.

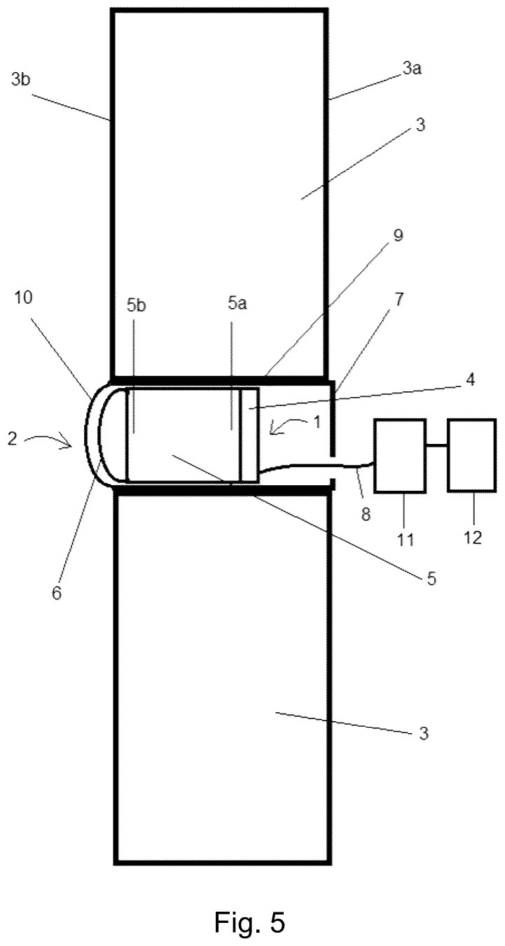

Referring to FIG. 5, the lighting system 2 may further comprise a controller 12 for operating the element 1 and a power supply 11 for powering the light source 4, the power supply 11 comprising an electrical connection element 8 for connecting the power supply 11 with the light source 4.

The optical element 1 is to be installed in the through hole, wherein the electrical connection element 8 may optionally be at least partially located inside the through hole, as illustrated in the figures.

The optical element 1 may be installed in the through hole, wherein the power supply 11 may optionally be at least partially located inside the through hole, contrarily to the illustration of FIG. 5.

In FIG. 1-5 and in FIG. 7, an opening of the housing 7 which is significantly larger than a diameter of the cable 8 is shown wherethrough the cable 8 can exit the housing 7. However, the skilled person understands that this opening does not need to be larger than a cross section of the cable as illustrated in the figures. Rather, a wall of the housing 7 may e.g. comprise a through hole with a diameter approximately the same as a diameter of the cable, yet at least somewhat greater than the diameter of the cable. Alternatively, the housing 7 may be left completely open on the inner side 3a of the wall 3. It is also envisaged that the housing 7 does not or only partially cover the part of the cable 8 that is located inside the through hole, as e.g. illustrated in FIG. 4.

The housing 7 may be affixed to the wall 3 by a fixation element 9, which can be a flange arranged on at least one end of the housing, multiple flanges, or a flange along the entire circumference of the housing 7. The fixation element 9 may also comprise grooves or ribs arranged on an outer circumference of the housing 7. The lighting system 2 may also further comprise a sealing element (optionally coinciding with the fixation element 9) arranged at an outer surface of the housing, wherein the sealing element makes contact with an inner surface of the through hole for shielding the housing of the wall.

The housing 7 may have a substantially cylindrical shape, following the contours of the through hole of the wall 3.

In FIG. 6, an example of a more detailed optical element 1 is shown arranged in a lighting system 2. A center line 1a of the optical element 1 is shown, which may coincide with a center line of the light source 4 and/or a center line of the light transmitting element 5 and/or a center line of the light directing element 6.

FIG. 6 illustrates an exemplary embodiment comprising at least one lens 13; here, three lenses are shown as part of the light directing element 6. The light directing element 6 may further comprise at least one reflective surface 14; in FIG. 6, two are shown.

The light source 4 may further comprise a printed circuit board (PCB) 16 comprising at least one light emitting element 18, e.g. arranged in a recess of the PCB 16.

The optical element 1 may further comprise positioning elements 15 for aligning the light source 4 with the light transmitting element 5. The positioning elements 15 may cooperate with cooperating elements 17, e.g. installed on the PCB 16, for better aligning the light source 4 with the light transmitting element 5. The positioning elements 15 may also be affixed to the PCB 16 and thus to light source 4, wherein the cooperating elements 17 are part of a mounting element 20.

Further, the light source may comprise at least one collimator 19.

The optical element 1 may also comprise a mounting element 20, e.g. at least one flange arranged near the light source 4, for affixing the optical element 1 to the housing 7. The at least one flange 20 may comprise holes for arranging fixating elements, such as screws, therethrough.

As shown in FIG. 6, the dome 10 may be part of the optical element 1 or in particular of the light directing element 6.

In all embodiments, the directing element 6 may entirely protrude from the through hole, or may partially protrude from the through hole, or may not protrude from the through hole.

The optical element 1 may be directly connected with the lighting system 2, e.g. via flange 20, which may be connected with a flange 7b of the housing 7.

As shown in FIG. 7, the housing 7 may comprise flanges 7a, 7b, 7c, 7d. Any of the flanges 7a, 7b, 7c, 7d may be omitted. The housing 7 may also comprise additional flanges. Flanges 7a may be arranged to encapsulate the light directing element 6, or to hold the dome 10 of the light directing element 6, or to hold the light directing element 6. In FIG. 6-7, the flanges 7a are shown not to directly make contact with the optical element 1, but may also be arranged to contact the light directing element 6. Flanges 7b may cooperate with the at least one flange 20 of the optical element 1.

The flanges 7a, 7b, 7c, 7d may each comprise at least one flange, or a circumferential flange, with a constant or varying protrusion length. Contrarily to what is illustrated in FIG. 6 and FIG. 7, it is thus possible to only arrange any one of the flanges 7a, 7b, 7c, 7d on one side of the housing 7, e.g. on a top side of the through hole. The flanges 7a, 7b, 7c, 7d may each comprise the same flange dimensions, or may comprise different flange realizations.

FIG. 7 illustrates that the housing 7 may extend along the entire length of the through hole.

Further, FIG. 7 shows flanges 7c for fixating or holding the PCB 16, and flanges 7d for holding the light directing element 6 in place.

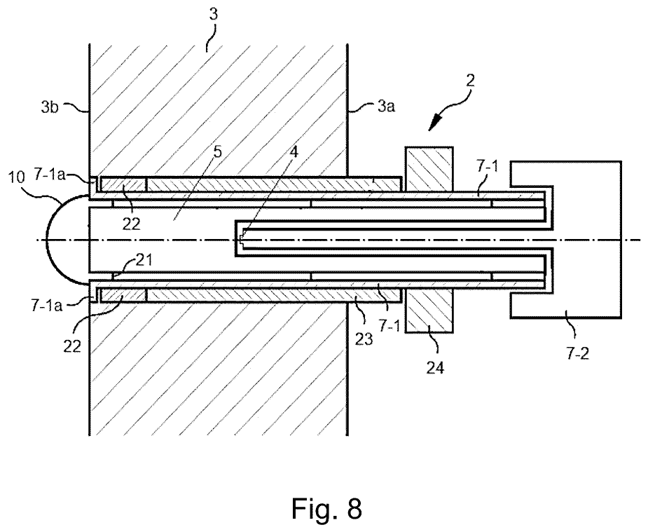

FIG. 8 illustrates another arrangement according to the disclosure.

In FIG. 8, it is illustrated that the housing 7 may comprise of multiple parts, e.g. two housing parts 7-1 and 7-2. In this figure, the first housing part comprises the light transmitting element 5 and the light source 4, wherein the second housing part comprises the light source 4. As such, the light source 4 is doubly protected. However, it may also be that the first housing part does not comprise the light source 4.

The lighting system 2 may further comprise an aligning element 21. FIG. 8 shows a sealing element 22 as discussed above.

FIG. 8 also shows that the lighting system may comprise additional components 23, 24, which may e.g. be arranged for compressing or tightening the optical element 1 and the lighting system 2, making it more compact and providing more reliable, fixed connections between the different components of the lighting system 2.

The first housing part 7-1 may comprise one or more flanges 7-1a, which, in combination with sealing element 22 and additional element 23, provides for a cylindrical shape of the entire lighting system 2, such that a shape of the lighting system 2 may correspond with a shape of the through hole of the wall 3.

The PCB 16 may be arranged at the light source 4 or may be connected to the light source 4.

For the purpose of clarity and a concise description, features are described herein as part of the same or separate embodiments, however, it will be appreciated that the scope of the invention may include embodiments having combinations of all or some of the features described. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain features are recited does not indicate that a combination of these features cannot be used to an advantage. Many variants will be apparent to the person skilled in the art. All variants are understood to be comprised within the scope of the invention as defined by the following claims.
1=through wall lighting optical element
1a=central axis of optical element
2=lighting system
3=wall comprising a through hole
4=light source
5=light transmitting element
6=light directing element
7=housing
7-1=first housing part
7-2=second housing part
7-1a=first housing part flange
8=electrical connection element
9=fixation element
10=dome
11=power supply
12=controller
13=lens(es) (3 are shown)
14=reflecting surface(s) (2 shown)=
15=positioning elements
16=PCB
17=cooperating elements
18=light emitting element (in a recess)
19=collimator
20=mounting element
21=aligning element
22=sealing element
23, 24=additional elements

1. Through wall lighting optical element for arrangement in a through hole of a wall of a wind turbine, comprising:
a light source; and
a light directing element for directing light outwardly from the through hole of the wall, wherein when the optical element is installed in the through hole, the light source is located inside of the through hole of the wall.

2. The optical element according to claim 1, further comprising a light transmitting element comprising a first end and a second end opposite to the first end, wherein the first end is coupled with the light source and wherein the second end is coupled with the light directing element.

3. Through wall lighting optical element for arrangement in a through hole of a wall of a wind turbine, comprising:
a light source;
a light transmitting element comprising a first end and a second end opposite to the first end, wherein the first end is coupled with the light source, wherein the first end is to be located inside the wall; and
a light directing element coupled with the second end of the light transmitting element for directing light outwardly from the through hole of the wall.

4. The optical element according to claim 3, wherein the first end is to be located between an inner side of the wall and an outer side of the wall.

5. The optical element according to claim 3, wherein the second end is to be located at or near an outer side of the wall.

6. The optical element according to claim 1, wherein the light source is a collimated light source.

7. The optical element according to claim 1, wherein the light source comprises a collimating optic for collimating light emitted by the light source.

8. The optical element according to claim 7, wherein the collimating optic comprises at least one lens.

9. The optical element according to claim 1, wherein the light source comprises a laser or at least one LED.

10. The optical element according to claim 1, wherein the light directing element comprises at least one lens.

11. The optical element according to claim 3, wherein the light transmitting element has a substantially cylindrical shape.

12. Through wall lighting system comprising:
the optical element according to claim 3; and
a housing, wherein the light transmitting element is arranged inside the housing or wherein the light transmitting element comprises the housing.

13. The system according to claim 12, wherein the light source is arranged inside the housing.

14. The system according to claim 12, further comprising a controller for operating the optical element and a power supply for powering the light source, the power supply comprising an electrical connection element for connecting the power supply with the light source.

15. The system according to claim 14, wherein, when the optical element is installed in the through hole, the electrical connection element is at least partially located inside the through hole.

16. The system according to claim 14, wherein, when the optical element is installed in the through hole, the power supply is at least partially located inside the through hole.

17. The system according to claim 12, wherein the housing is configured to be affixed to the wall by a fixation element.

18. The system according to claim 17, wherein the fixation element comprises a flange arranged on one end of the housing.

19. The system according to claim 12, further comprising an auxiliary element arranged to mount a controller and/or a power supply to the inner wall.

20. Wind turbine comprising at least one lighting system according to claim 12.
